(19) United States
(12) Patent Application Publication
(10) Pub. No.: US 2019/0333125 A1
(43) Pub. Date: Oct. 31, 2019

(54) SYSTEM AND METHOD FOR RENDERING PRICE INFORMATION

(71) Applicant: Walmart Apollo, LLC, Bentonville, AR (US)

(72) Inventors: Donald R. High, Noel, MO (US); John C. Crecelius, JR., Springdale, AR (US); Nicholaus A. Jones, Fayetteville, AR (US); Matthew A. Jones, Bentonville, AR (US); Robert J. Taylor, Rogers, AR (US)

(21) Appl. No.: 16/372,575

(22) Filed: Apr. 2, 2019

Related U.S. Application Data
(60) Provisional application No. 62/663,389, filed on Apr. 27, 2018.

(51) Int. Cl. G06Q 30/06; G09G 5/00

(52) U.S. Cl. CPC G06Q 30/0623; G09G 2340/12; G09G 2380/04; G09G 5/005

(57) ABSTRACT

A price label is created, positioned, and dimensioned according to pricing information, regulatory information, location information, and dimensions of the screen. The price label is inserted into or over display content to form labeled pricing content. The labeled pricing content is transmitted to the electronic product such that the electronic product renders the labeled pricing content on the display screen.

### CROSS-REFERENCE TO RELATED APPLICATION

This application claims the benefit of the following U.S. Provisional Application No. 62/663,389 filed Apr. 27, 2018, which is incorporated herein by reference in its entirety.

### TECHNICAL FIELD

These teachings relate to the display of pricing information at products and, more specifically, to displaying information on products that include display screens or other types of rendering devices.

### BACKGROUND

Labels are used to display price information on products. For example, paper labels or stickers are placed on televisions, computer displays, and smartphones to indicate the price of these items.

Frequently, these pricing labels need to be changed. For example, a sale may occur and the current pricing information is not accurate. In this situation, the label needs to be changed because the old price information is incorrect. Changing the price information is typically labor intensive as employees in the store are deployed to replace the old label with a new label or manually mark over the old price on the label with the new price. Consequently, these previous approaches are expensive to utilize.

Additionally, these previous approaches could not react quickly to price changes. For example, a product might have a reduced price for only a few hours during a sale and then the price is returned to an original price. Previous approaches had difficulty keeping up with these changes and doing so in a cost-effective way.

### BRIEF DESCRIPTION OF THE DRAWINGS

The above needs are at least partially met through the provision of approaches that display pricing information on displays of electronic products, wherein:

FIG. 1 comprises a diagram of aspects of a system as configured in accordance with various embodiments of these teachings;

FIG. 2 comprises a diagram of aspects of a system as configured in accordance with various embodiments of these teachings;

FIG. 3 comprises a flowchart as configured in accordance with various embodiments of these teachings;

FIG. 4 comprises a flowchart as configured in accordance with various embodiments of these teachings;

FIG. 5 comprises a flowchart as configured in accordance with various embodiments of these teachings;

FIG. 6 comprises a diagram of aspects of a system as configured in accordance with various embodiments of these teachings.

### DETAILED DESCRIPTION

Generally speaking, a system renders a price label to a customer on an existing display screen of an electronic product such as a smartphone or a television. The electronic product is desired to be sold. An electronic mixing device at the retail store or in the product receives the price of the product from a central location. Based upon the location of the product (e.g., the city or state the product is being sold), dimensions of the display screen, and regulatory information (e.g., particular placement or size requirements of a city or state), the device creates a price label. The device then inserts the price label into display content (e.g., a movie or screen background) for rendering on the display screen. The status of the product, e.g., activated or deactivated, may be sent to a central control center or employee so that the product can be re-activated when deactivated.

Advantageously, the present approaches allow prices to be changed quickly over time. For example, an original price may be displayed on a display, adjusted to a sale price for a few hours, and then returned to the original price quickly and seamlessly without the manual adjustment and/or removal of paper labels or price stickers. In aspects, the approaches described herein allow the price to be seen by a potential customer at the same time the customer can ascertain desirable features of the product. For instance, the customer may be able to see both the price and clarity/sharpness/definition of rendered screen content (e.g., a movie) on a large screen television.

In the approaches described herein, paper or plastic labels on electronic devices (e.g., televisions, computers, cellular phones, or smartphones) are replaced with a price to be indicated on the preexisting screen of the device. In aspects, the USB port of the various devices is accessed allowing dynamic pricing to be communicated to the screen and displayed. Alternatively, any suitable physical or wireless mechanism or approach may be used to supply data to the screen.

The label (or price display) may also include content (e.g., movies, advertisements, photos, menus, or be null). In examples, the display has requirements, and certain portions of a displayed price have statutory requirements (e.g., New York requiring ¾″ displays and Massachusetts requiring a 1″ tall display). In some jurisdictions, tax must be included in the price. In aspects, these approaches automatically determine the geographic location of the present device and project the appropriate values and sizes as required on the price label. In other examples, as screen sizes vary, the system determines the display size of the electronic device and adjusts the price label such that it meets its statutory actual display size requirements.

In examples, the display process could be intermittent to prevent burn-in and to allow the user to “test-drive” the product. For “test driving,” the label may relocate from a high visibility location (e.g., centered, lower right, etc.), to a low-intrusiveness location (e.g., upper right, or 2″ up and 2″ in from lower left corner) or disappear altogether. After a certain period of inactivity (e.g., a few seconds), the label would come back up and be re-displayed. In other aspects, if a remote control (for a television) is being used (e.g., activated in any way), or if a mouse is occupied or moved (e.g., at a computer), the price label disappears.

In many of these embodiments, a system is configured to display pricing information on a product display screen. The system includes an electronic product (with an existing product display screen), an electronic communications network, a central processing center, and an electronic mixing apparatus.

The electronic product is disposed at a retail store. The central processing center is coupled to the electronic communications network and configured to determine and provide pricing information concerning the electronic product.

The electronic mixing apparatus is disposed at the retail store or in the electronic product and is communicatively coupled to the electronic communications network. The electronic mixing apparatus comprises a control circuit, a database, a transceiver circuit, and a sensor.

The sensor obtains location information concerning the current location of the product. The transceiver circuit is configured to receive the pricing information from the electronic communications network.

The database is configured to store video content to be rendered on the display screen. The database is also configured to store regulatory information. The regulatory information describes a required position and dimensions of a price label on the display screen. The database also stores dimensions of the screen.

The control circuit is configured to create, position, and dimension the price label according to the pricing information, the regulatory information, the location information, and the dimensions of the screen. The control circuit is also configured to insert the price label into or over the display content to form labeled pricing content. The control circuit is still further configured to transmit the labeled pricing content to the electronic product such that the electronic product renders the labeled pricing content on the display screen. The control circuit is yet further configured to transmit status information to the central processing center or to an employee in the store via the transceiver circuit. The status information is received from the electronic product and indicates a status of the electronic product such that the employee or a robot can be instructed to re-activate the electronic product when the electronic product has become deactivated.

In aspects, the electronic product is a television, a computer, or a smartphone. Other examples are possible.

In examples, the price label is displayed intermittently on the display screen. In other examples, the control circuit is configured to add tax amounts to the pricing information for inclusion in the label.

In other examples, the electronic mixing apparatus is coupled to the electronic product via a USB port at the electronic product. In still other examples, the electronic mixing apparatus is coupled to the electronic product via a wired or wireless connection.

In other aspects, the display content is a movie, an advertisement, or null content. Other examples are possible.

In some examples, the electronic mixing apparatus comprises at least in part a software application. In yet other examples, the status of the electronic product is activated or deactivated.

In others of these embodiments, an electronic product is disposed at a retail store, and the electronic product includes a display screen. A central processing center is configured to determine and provide pricing information concerning the electronic product.

At an electronic mixing apparatus that is disposed at the retail store or in the electronic product, location information concerning the current location of the product is obtained. At the electronic mixing apparatus, the pricing information is received from the central processing center via an electronic communications network.

At the electronic mixing apparatus, video content to be rendered on the display screen is stored. Regulatory information is also stored and the regulatory information describes a required position and dimensions of a price label on the display screen. The dimensions of the screen are also stored.

At the electronic mixing apparatus, the price label is created, positioned, and dimensioned according to the pricing information, the regulatory information, the location information, and the dimensions of the screen. The price label is inserted into or over the display content to form labeled pricing content. The labeled pricing content is transmitted to the electronic product such that the electronic product renders the labeled pricing content on the display screen.

Status information is sent from the electronic product or mixing device to the central processing center or to an employee in the store. The status information indicates a status of the electronic product such that the employee or a robot can be instructed to re-activate the electronic product when the electronic product has become deactivated.

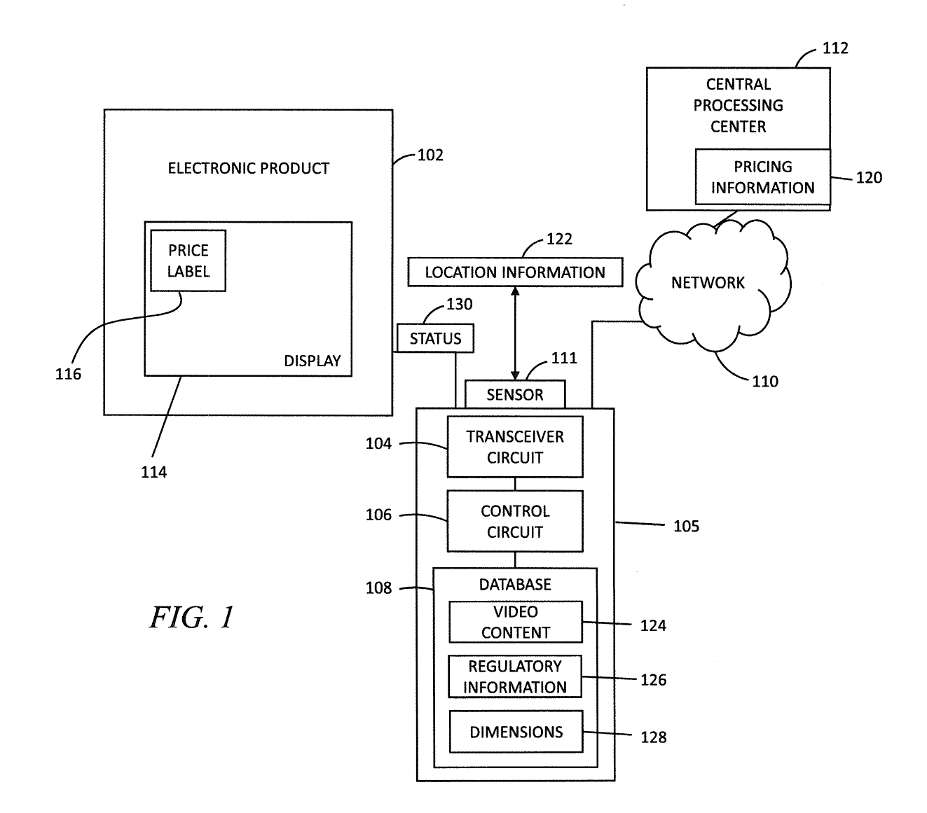

Referring now to FIG. 1, a system is configured to display pricing information on a product display screen. The system includes an electronic product 102 (with a product display screen 114), an electronic communications network 110, a central processing center 112, and an electronic mixing apparatus 105.

The electronic product 102 is disposed at a retail store. The screen 114 is fully integrated with the product 102 and may be any type of screen (e.g., touch screen, display-only screen). That is, the product inherently includes a screen that provides other functions. In aspects, the electronic product 102 is a television, a computer, or a smartphone. Other examples are possible.

The central processing center 112 is coupled to the electronic communications network 110 and configured to determine and provide pricing information 120 concerning the electronic product. In examples, the central processing center 112 is a home office or headquarters and may be implemented at least in part with general purpose computing devices. Pricing information for electronic or other products may be determined manually or automatically.

The electronic communications network 110 may be any network or combination of networks. In examples, the electronic communications network 110 may be the internet, a cellular network, a wide area network, a local network, a WI-FI network, or combinations of these or other networks.

The electronic mixing apparatus 105 is disposed at the retail store and is communicatively coupled to the electronic communications network 110. The electronic mixing apparatus 105 includes a control circuit 106, a database 108, a transceiver circuit 104, and a sensor 111.

The sensor 111 may be any type of sensor that obtains location information 122 concerning the current location of the product. In some aspects, the sensor 111 is an electronic interface or port that receives location information from employees, translates the information, and forwards the information to the control circuit 106. In some examples, the sensor 111 is eliminated and such information is received directly by the transceiver circuit 104. In other examples, the sensor 111 obtains information (e.g., visual images and the sensor 111 is a camera) concerning the physical environment that is sufficient to identify the location of the product. The location information 122 may be geographic coordinates or identify the location (e.g., city, state, or country). In yet other examples, the sensor 111 may obtain location determination information such as from a GPS system. Other examples of sensors and location information are possible.

The transceiver circuit 104 is configured to receive the pricing information from the electronic communications network 110. The transceiver circuit 104 may be configured to translate information, signals, or transmissions between different formats.

The database 108 is any type of memory storage device and is configured to store video content 124 to be rendered on the display screen. The database 108 is also configured to store regulatory information 126. The regulatory information 126 describes a required position and dimensions of a price label on the display screen. In addition or in place of the regulator information 126, geographic preference information may also be stored and considered. For example, it may be known from consumer studies that customers in certain geographic locations have preferences with respect to price label characteristics (e.g., size, color, or other types of information to be displayed). The database 108 also stores dimensions 128 of the screen 114.

It will be appreciated that as used herein the term “control circuit” refers broadly to any microcontroller, computer, or processor-based device with processor, memory, and programmable input/output peripherals, which is generally designed to govern the operation of other components and devices. It is further understood to include common accompanying accessory devices, including memory, transceivers for communication with other components and devices, etc. These architectural options are well known and understood in the art and require no further description here. The control circuit 106 may be configured (for example, by using corresponding programming stored in a memory as will be well understood by those skilled in the art) to carry out one or more of the steps, actions, and/or functions described herein.

The control circuit 106 is configured to create, position, and dimension the price label 116 according to the pricing information 120, the regulatory information 126, the location information 122, and the dimensions 128 of the screen. The control circuit 106 is configured to insert the price label 116 into or over the content 124 to form labeled pricing content. In these regards, the control circuit 106 may include hardware and/or software that is effective to physically combine two separate data streams, i.e., the content 124 and the label information (describing the label 116). In other aspects, the display content is a movie, an advertisement, or null content. Other examples are possible.

The control circuit 106 is configured to transmit the labeled pricing content to the electronic product 102 such that the electronic product 102 renders the labeled pricing content on the display screen 114. In other examples, the control circuit 106 is configured to add tax amounts to the pricing information 120 for inclusion in price shown in the label 116.

The control circuit 106 is still further configured to transmit status information 130 obtained from the product 102 to the central processing center 112 or to an employee in the store via the transceiver circuit 104. In examples, the status of the electronic product is activated or deactivated. The status information 130 is received at the mixing apparatus 105 from the electronic product 102 and indicates a status of the electronic product 102 such that the employee or a robot can be instructed to re-activate the electronic product 102 when the electronic product 102 has become deactivated.

For example, an automated ground vehicle or aerial drone in the retail store may be instructed (e.g., by an employee, the central processing center 112, or the control circuit 106) to navigate through the store to the location of the product 102. The automated vehicle or aerial drone may be configured to find an optimal (e.g., shortest route) from its present location to the product 102.

The automated ground vehicle or aerial drone may include arms or other members that are configured to, for example, push a button or throw a switch on the electronic product 102 to re-activate the product 102 when the product 102 was determined to be deactivated. The automated ground vehicle or aerial drone may also include sensors such as cameras and may evaluate the information from the sensors in order to reactivate the electronic product 102. For example, camera images that include the product may be evaluated by the automated ground vehicle or aerial drone, the control circuit 106, and/or the central processing center 112 to verify that the product 102 is actually deactivated. In aspects, image processing software may determine whether an image of a product's display screen 114 shows that the screen 114 is activated (e.g., presenting and image) or deactivated (e.g., black and not presenting an image). If the product 102 is verified to have been or is deactivated, then the automated ground vehicle or aerial drone may proceed to reactivate the product 102. Information from the sensors may also be used to determine whether the product 102 has been moved from its optimal display location or is not properly facing customers (e.g., the product's screen is facing down). If the product 102 has been improperly moved or is improperly placed so it is not facing customers, then the automated ground vehicle or aerial drone may be used to re-orient or move the product 102 so that the product 102 is properly placed. Additionally, the automated ground vehicle or aerial drone may make a connection to the product 102 (e.g., wirelessly or using a cable connection), obtain other data from or related to the product's condition or status, and determine if the product 102 has operational issues (e.g., the screen has malfunctioned or is broken). In this case, the automated ground vehicle or aerial drone may find another product of the same type, place this product properly in the store (e.g., at the correct product display and facing customers), and activate the replacement product so that price information can be displayed. In the case of a malfunctioning product, the automated ground vehicle or aerial drone may also remove the product 102 from the retail area.

In examples, the price label 116 is displayed intermittently on the display screen 114. This would prevent burn-in on the screen 114 and allow a customer in the store to test the product. When the product was being tested, the label 116 that is being displayed may be relocated from a high-visibility position on the screen 114 (e.g., the center of the screen 114) to a low-visibility position (e.g., a corner of the display screen 114), or may disappear altogether. Testing may be sensed when, for example, a customer touches a button on the screen or otherwise interacts with the product (e.g., moves a computer mouse or presses a button on a remote control). After a period of product inactivity (e.g., a few seconds) the label 116 may be redisplayed or redisplayed in the original location before the test began.

In other examples, the electronic mixing apparatus 105 is coupled to the electronic product 102 via a USB port at the electronic product 102. In still other examples, the electronic mixing apparatus 105 is coupled to the electronic product 102 via a wired or wireless connection.

It will be appreciated that the electronic product 102 may itself include a control circuit, database and transceiver circuit. In this case, the electronic mixing apparatus 105 may communicate with these devices to display the labeled pricing content on the display screen 114. Alternatively, the electronic product 102 may receive the information and directly display the labeled pricing content on the display screen 114.

It will be additionally appreciated that other information may be included in the price label 116 besides the price and that this information may also dynamically change. For example, the unit price may also be displayed (and may be required to be displayed in some jurisdictions). Additionally, the size, shape, color or other graphical display characteristics of the price (e.g., the price may be flashing) may be adjusted over time without further processing by the electronic product 102.

It will be further understood that the electronic labels, content, and labeled pricing content are in electronic form and are transmitted between locations as electronic signals. The electronic labels, content, and labeled pricing content may be of any type of format and follow any electronic protocol.

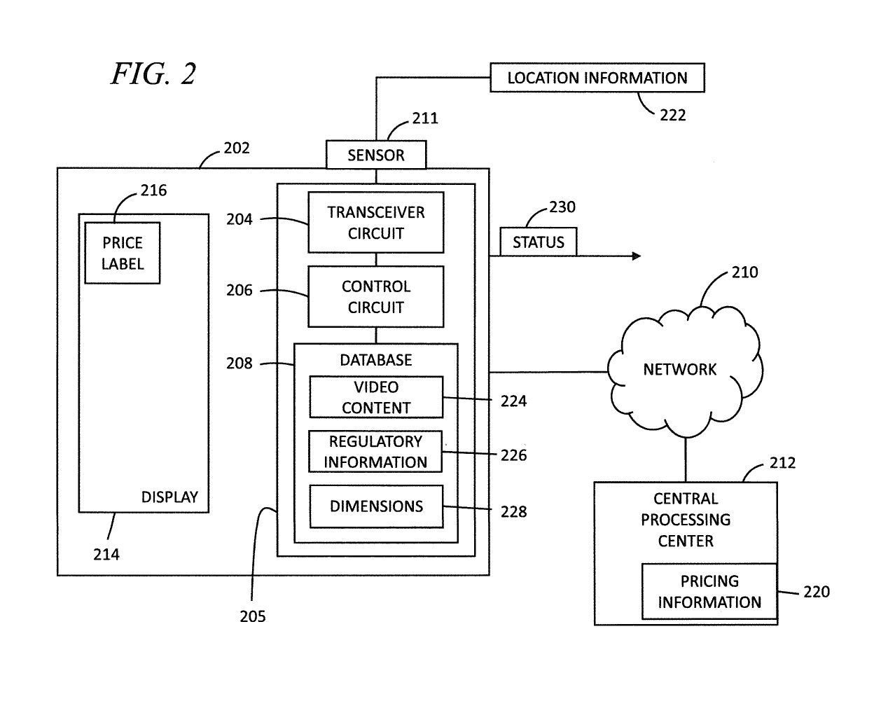

Referring now to FIG. 2, a system is configured to display pricing information on a product display screen. The system includes an electronic product 202 (with a product display screen 214), an electronic communications network 210, a central processing center 212, and an electronic mixing apparatus 205.

It will be appreciated that the example of FIG. 2 is similar to the example of FIG. 1 except that the electronic mixing apparatus is included in or incorporated into the electronic product. In these regards, the electronic mixing apparatus may be implemented at least in part by a software application (app) that is executed at a control circuit as described herein.

The electronic product 202 is disposed at a retail store. The screen 214 is fully integrated with the product 202 and may be any type of screen (e.g., touch screen, display-only screen). That is, the product 202 inherently includes a screen that provides other functions. In aspects, the electronic product 202 is a television, a computer, or a smartphone. Other examples are possible.

The central processing center 212 is coupled to the electronic communications network 210 and is configured to determine and provide pricing information 220 concerning the electronic product. In examples, the central processing center 212 is a home office or headquarters and may be implemented at least in part with general purpose computing devices. Pricing information for electronic or other products may be determined manually or automatically.

The electronic communications network 210 may be any network or combination of networks. In examples, the electronic communications network 210 may be the internet, a cellular network, a wide area network, a local network, a WI-FI network, or combinations of these or other networks.

The electronic mixing apparatus 205 is disposed in the electronic product 202 and is communicatively coupled to the electronic communications network 210. The electronic mixing apparatus 205 includes a control circuit 206, a database 208, a transceiver circuit 204, and a sensor 211. These devices may be the devices already present or existing in the electronic product 202. In other words, the approach of FIG. 2 may be implemented as a separate software application that utilizes hardware electronic components already existing in the electronic product 202. If the control circuit 206, database 208, and/or transceiver circuit 204 already exist at the product 202 and are used to execute the software application, then these devices perform functions inherent to or required by the electronic product 202 (e.g., sound processing functions when the electronic product 202 is a smartphone).

The sensor 211 may be any type of sensor that obtains location information 222 concerning the current location of the product. In some aspects, the sensor 211 is an electronic interface or port that receives location information from employees, translates the information, and forwards the information to the control circuit 206. In some examples, the sensor 211 is eliminated and such information is received directly by the transceiver circuit 204. In other examples, the sensor 211 obtains information (e.g., visual images if the sensor 211 is a camera) concerning the physical environment that is sufficient to identify the location of the product. The location information 222 may be geographic coordinates or identify the location (e.g., city, state, or country). In yet other examples, the sensor may obtain location determination information such as from a GPS system. Other examples of sensors and location information are possible.

The transceiver circuit 204 is configured to receive the pricing information from the electronic communications network 210. The transceiver circuit 204 may be configured to translate information, signals, or transmissions between different formats.

The database 208 is any type of memory storage device and is configured to store video content 224 to be rendered on the display screen. The database 208 is also configured to store regulatory information 226. The regulatory information 226 describes a required position and dimensions of a price label on the display screen 214. In addition or in place of the regulatory information 226, geographic preference information may also be stored and considered. For example, it may be known from consumer studies that customers in certain geographic locations have preferences with respect to price label characteristics (e.g., size, color, or other types of information to be displayed). The database 208 also stores dimensions 228 of the screen 214.

It will be appreciated that as used herein the term “control circuit” refers broadly to any microcontroller, computer, or processor-based device with processor, memory, and programmable input/output peripherals, which is generally designed to govern the operation of other components and devices. It is further understood to include common accompanying accessory devices, including memory, transceivers for communication with other components and devices, etc. These architectural options are well known and understood in the art and require no further description here. The control circuit 206 may be configured (for example, by using corresponding programming stored in a memory as will be well understood by those skilled in the art) to carry out one or more of the steps, actions, and/or functions described herein.

The control circuit 206 is configured to create, position, and dimension the price label 216 according to the pricing information 220, the regulatory information 226, the location information 222, and the dimensions 228 of the screen. The control circuit 206 is configured to insert the price label 216 into or over the content 224 to form labeled pricing content. In these regards, the control circuit 206 may include hardware and/or software that is effective to physically combine two separate data streams, i.e., the content 224 and the label information (describing the label 216). In other aspects, the display content is a movie, an advertisement, or null content. Other examples are possible.

The control circuit 206 is configured to transmit the labeled pricing content to the electronic product 202 such that the electronic product 202 renders the labeled pricing content on the display screen 214. In other examples, the control circuit 206 is configured to add tax amounts to the pricing information 220 for inclusion in the price shown in the label 216.

The control circuit 206 is still further configured to transmit status information 230 to the central processing center 212 or to an employee in the store via the transceiver circuit 204. In examples, the status of the electronic product is activated or deactivated. The status information 230 is obtained internally at the electronic product 202. For example, a control circuit at the product 202 (e.g., the control circuit 206) may have access to data storage locations in the database 208 that indicate the status (e.g., activated or deactivated) of the product 202. The status information 230 indicates a status of the electronic product 202 such that the employee or a robot can be instructed to re-activate the electronic product 202 when the electronic product 202 has become deactivated. The robot may be an automated ground vehicle or aerial drone and this may be used as described above with respect to FIG. 1 to reactivate the product 202 and to perform other functions (as described with respect to FIG. 1).

In examples, the price label 216 is displayed intermittently on the display screen 214. This would prevent burn-in on the screen 214 and allow a customer in the store to test the product. When the product was being tested, the label 216 that is being displayed may be relocated from a high-visibility position on the screen 214 (e.g., the center of the screen 214) to a low-visibility position (e.g., a corner of the display screen 214), or may disappear altogether. Testing may be sensed when, for example, a customer touches a button on the screen 214 or otherwise interacts with the product (e.g., moves a computer mouse or presses a button on a remote control). After a period of product inactivity (e.g., a few seconds) the label 216 may be redisplayed or redisplayed in the original location before the test began.

In other examples, the electronic mixing apparatus 205 is coupled to the electronic product 202 via a USB port at the electronic product 202. In still other examples, the electronic mixing apparatus 205 is coupled to the electronic product 202 via a wired or wireless connection.

It will be additionally appreciated that other information may be included in the price label 216 besides the price and that this information may also dynamically change. For example, the unit price may also be displayed (and may be required to be displayed in some jurisdictions). Additionally, the size, shape, color or other graphical display characteristics of the price (e.g., the price may be flashing) may be adjusted over time.

It will be further understood that the electronic labels, content, and labeled pricing content are in electronic form and are transmitted between locations as electronic signals. The electronic labels, content, and labeled pricing content may be of any type of format and follow any electronic protocol.

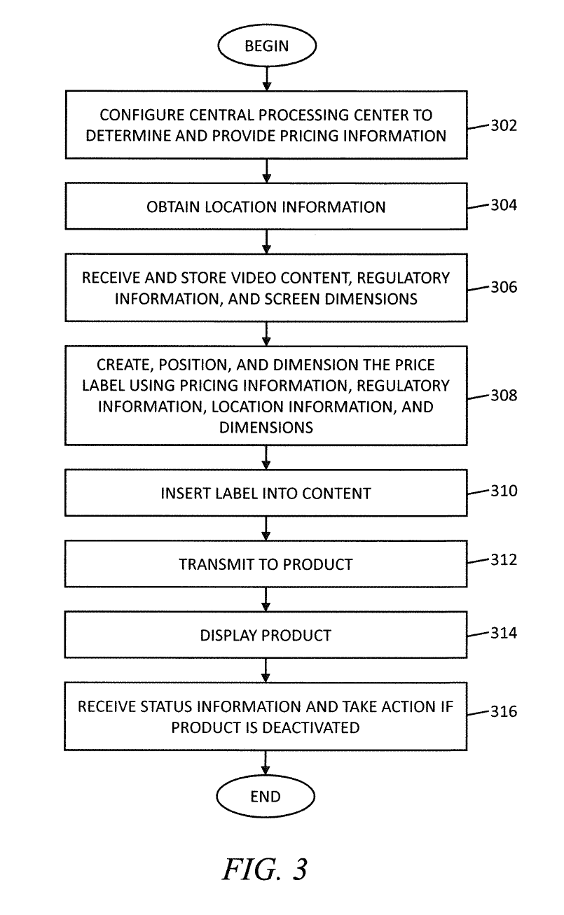

Referring now to FIG. 3, one example of rendering a price label on a screen of an electronic product is described. In this example, an electronic product is disposed at a retail store. The electronic product includes a display screen. In examples, the electronic product may be a laptop, tablet, personal computer, or smartphone. Other examples are possible.

At step 302, a central processing center is configured to determine and provide pricing information concerning the electronic product. Other types of information (e.g., price per unit, for instance, price per gallon; product name; or product identifier). The central processing center may be located remotely from the retail store. In other examples, the central processing center may be located at the retail store.

An electronic mixing apparatus may be disposed within or external to the electronic product. If externally located to the electronic product, the mixing apparatus may be in the retail store and/or in proximity to the product. If internal to the product, the electronic mixing apparatus may be a software “app” or application.

At step 304, the electronic mixing apparatus obtains location information concerning the current location of the product. In examples, an employee or supervisor in the store manually enters the information into the mixing apparatus (e.g., having the location information sensed by a scanner or typing the information at a user interface coupled to the electronic mixing apparatus). In other examples, the mixing device may automatically determine its location by sensing where it is (e.g., using sensed images, or receiving information from a location determination system such as a GPS system).

At step 306, the electronic mixing apparatus receives and stores video content to be rendered on the display screen. In examples, this content may be a movie, television program, background image, or no content (null content). The electronic mixing apparatus also receives and stores regulatory information. The regulatory information in aspects describes a required position and dimensions, color, or other physical characteristics of a price label on the display screen. The electronic mixing apparatus also receives and stores dimensions of the screen (exact dimensions, e.g., in inches; relative dimensions such as large, medium, or high; or type of device, e.g., smartphone or large screen television).

At step 308, the electronic mixing apparatus creates, positions, and dimensions the price label according to the pricing information, the regulatory information, the location information, and the dimensions of the screen. The electronic mixing apparatus inserts the price label into or over the display content to form labeled pricing content at step 310 and, at step 312, transmits the labeled pricing content to the electronic product. At step 314, the electronic product renders the labeled pricing content on the display screen.

At step 316, the electronic product transmits status information to the central processing center or to an employee in the store, for example, via the mixing apparatus. The status information may be transmitted regularly. In other examples, the status information is transmitted upon a change of status. In other aspects, the status information may be transmitted over a wired or wireless connection. The status information indicates a status (e.g., activated or deactivated) of the electronic product such that the employee or a robot can be instructed (e.g., using a wired or wireless connection) by the central processing center, the person, the electronic mixing apparatus, or by a mobile device to re-activate the electronic product when the electronic product has become deactivated (e.g., the status is “deactivated”). For example, the central processing center, the person, the electronic mixing apparatus, or the mobile device may determine the status to be “deactivated” and responsively issue electronic instructions to the robot. The robot may be an aerial drone or an automated ground vehicle. Other examples of robots are possible.

The robot may include arms or other members that are configured to, for example, push a button or throw a switch on the electronic product to re-activate the product. The robot may also include sensors such as cameras and may evaluate the information from the sensors in order to reactivate the electronic product. For example, camera images that include the product may be evaluated by the robot and/or the central processing center to verify that the product is actually deactivated. In aspects, image processing software may determine whether an image of a product's display screen shows that the screen is activated (e.g., presenting and image) or deactivated (e.g., black and not presenting an image). If the product is verified to be deactivated, then the robot may proceed to reactivate the product. Information from the sensors may also be used to determine whether the product has been moved from its optimal display location or is not properly facing customers (e.g., the product's screen is facing down). If the product has been improperly moved or is improperly placed so it is not facing customers, then the robot may be used to re-orient or move the product so that the product is properly placed. Additionally, the robot may make a connection to the product (e.g., wirelessly or using a cable connection), obtain other data from or related to the product's condition or status, and determine if the product has operational issues (e.g., the screen has malfunctioned or is broken). In this case, the robot may find another product of the same type, place this product properly in the store (e.g., at the correct product display and facing customers), and activate the replacement product so that price information can be displayed. In the case of a malfunctioning product, the robot may also remove the product from the retail area.

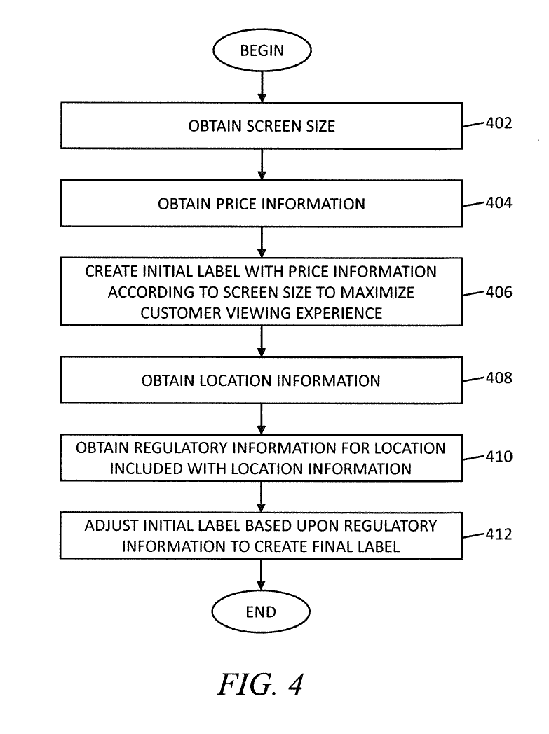

Referring now to FIG. 4, one example of an approach for displaying a price label on a display screen of an electronic product is described.

At step 402, the screen size is obtained. In examples, this may be the absolute dimensions of the screen or the type of device (e.g., smartphone or large screen television) where the screen is located.

At step 404, price information is obtained. The price information is the price of the electronic product. Other types of information (e.g., price per unit) may also be included.

At step 406, an initial price label is created with the price information according to a screen size that maximizes the customer viewing experience. In examples, a look-up table may match screen sizes to templates of initial price labels. The templates may include a base label of predetermined size, color, arrangement, or other characteristics. The initial price labels may be determined so that the average customer can visually discern the label. For instance, if the label is too small the customer cannot see the label. On the other hand, the label may be too large and dominate the display so that the features of the display are not viewable (causing the customer to not wish to purchase the product).

At step 408, location information is obtained. The location information specifies or identifies the geographic location of the product or the location where the product is disposed. For example, the city, state, or country where the product is located is obtained. In example, an employee of a retail store where the product is located enters or determines this information.

At step 410, regulatory information is obtained for the location specified in the location information. The regulatory information may include sizing requirements of the numerals in the displayed price (e.g., the numbers must be at least an inch tall), the color of the numerals, requirements for the position of the label on the screen (e.g., the label must be displayed in the upper left corner of the screen), or the inclusion of tax information (e.g., the total price must include the tax charged). Other examples are possible.

At step 412, the initial label is adjusted based upon the regulatory information to create a final label. The final label may be electronically or digitally combined or overlaid onto screen content and some combination of the label and content rendered on the display screen.

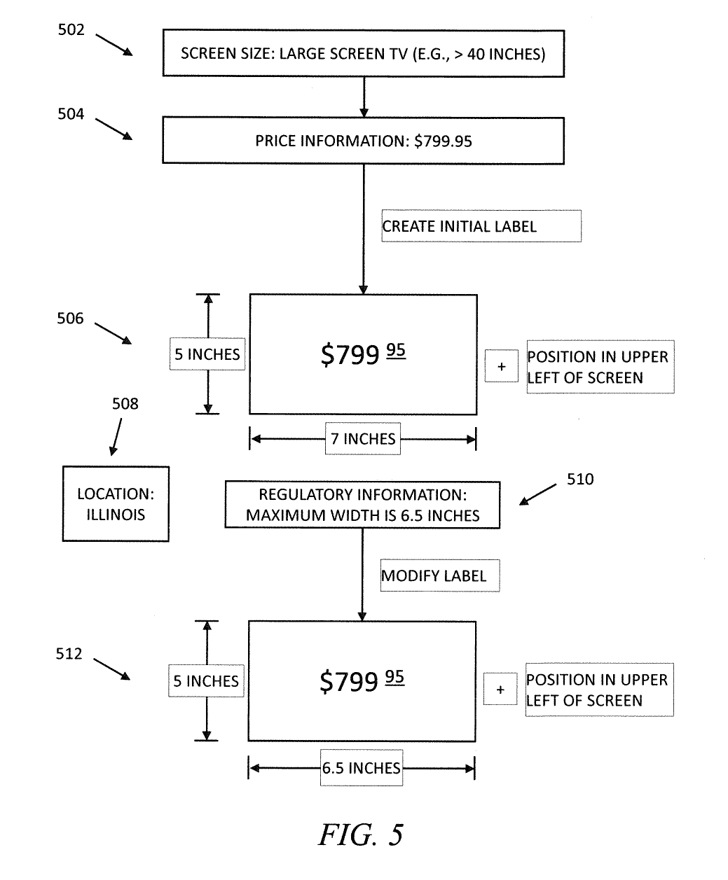

Referring now to FIG. 5, one example of an approach for displaying a price label on a display screen of an electronic product is described. The example of FIG. 5 in aspects corresponds to the execution of the approach described in FIG. 4 (the corresponding step of FIG. 4 are shown as parentheticals).

Size information 502 is obtained (step 402). In this example, the size information 502 indicates the screen size is for a large screen television set (greater than 40 inches).

Price information 504 is also obtained (step 404). In this example, the price information indicates that the price of the product is $799.95. An initial label 506 is created (step 406). The initial label is 5 inches by 7 inches and is positioned at the upper left corner of the display. A mapping table may be used to map sizes to initial label templates.

Location information 508 (indicating the product is in Illinois) is obtained (step 408). Regulatory information 510 (e.g., in Illinois, the maximum label width for a label is 6.5 inches) is also obtained (step 410). The label is modified to create a modified label 512 that is 5 by 6.5 inches in dimensions and positioned at the upper left corner of the display (step 412).

It will be appreciated that the example of FIG. 5 is one example, and that other examples are possible.

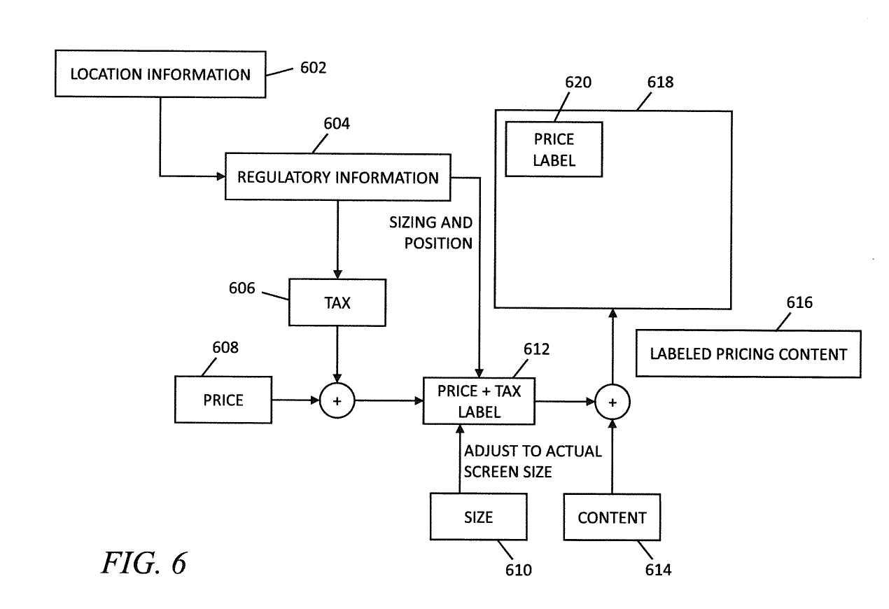

Referring now to FIG. 6, one example of an approach for displaying a price label on a display screen of an electronic product is described. Location information 602 describes the location of a display screen 618 of an electronic product. A displayable electronic label 620 is created to be displayed on the display screen 618. The location information 602 may be the city, state, or geographic coordinates of the product. The location information 602 may be obtained, in aspects, by an employee of the retail store where the product is located entering the information. In other examples, the location information 602 is obtained by other approaches such as determining the coordinates in a GPS positioning system.

Regulatory information 604 includes specifications of how the display is to be made and physical characteristics of the display, and may be organized according to a particular geographic location or jurisdiction (e.g., city, state, or country). The regulatory information 604 may include the size of the numerical values (e.g., one inch high), color of the values, font of the values, or positioning of the values on the display (e.g., price label must be displayed in the upper left corner of the display). In addition, some jurisdictions may require that the displayed price include sales or other taxes. Consequently, a tax value 606 may be obtained (which, in some examples, is a percentage rate multiplied by the actual price of the product). The location information 602 is applied to the regulatory information 604 to obtain sizing and positioning information (describing the sizing and positioning of the label) and the tax value 606.

The size (e.g., length and width) 610 of the display screen 618 is also obtained. In some examples, the display screen 618 may be a relative small size, while in other examples, the display screen 618 may be a relative larger size (e.g., a large screen television).

A price 608 of the item is also obtained. The price 608 is added to any tax value 606 and an electronic label 612 is created. In example, the electronic label 612 may be dimensioned according to a default size based upon the size 610. For instance, if it is known that the size 610 is of dimensions corresponding to a smartphone screen, then the size of the label 612 may be mapped to a size having predetermined dimensions (e.g., either absolute dimensions or occupying a predetermined portion of the screen). The default-sized label 612 is adjusted (either in overall dimensions or of the price displayed) according to the regulatory information. For instance, the size or color of the numerical characters of the price may be adjusted. The electronic label 612 may include or be associated with positioning information. The positioning information, in one example, describes where on the display screen 618 the label is to be displayed.

Content 614 for the display screen 618 is also obtained. The content may be a movie or a background image to mention two examples. In other examples, the content may be a blank image (e.g., null content), or simply no content at all. The content 614 is electronically combined (e.g., with a control circuit that is configured to electronically mix or combine two different data streams) with the electronic label 612 to form labeled pricing content 616 (which includes the overall screen content, e.g., the movie or background image, as well as the displayable price label 620. Combining the electronic label 612 and content 614 (to form labeled pricing content 616) may include digitally overlaying the electronic label 612 over the content 614, digitally replacing portions of the content 614 with the electronic label 612, or somehow digitally merging the electronic label 612 into portions of the content 614.

It will be appreciated that the approach described with respect to FIG. 6 may be performed within the electronic product (e.g., using a control circuit already present in the electronic product), at a device external to the electronic product, or some combination of these approaches.

It will be further understood that the electronic label 612, content 614, and labeled pricing content 616 are in electronic form and are transmitted between locations as electronic or electrical signals. The electronic label 612, content 614, and labeled pricing content 616 may be of any type of format and conform to any protocol.

Those skilled in the art will recognize that a wide variety of modifications, alterations, and combinations can be made with respect to the above described embodiments without departing from the scope of the invention, and that such modifications, alterations, and combinations are to be viewed as being within the ambit of the inventive concept.

What is claimed is:

1. A system that is configured to display pricing information on a product display screen, the system comprising:
an electronic product being disposed at a retail store, the electronic product including a display screen;
an electronic communications network;
a central processing center, the central processing center coupled to the electronic communications network and configured to determine and provide pricing information concerning the electronic product;
an electronic mixing apparatus that is disposed at the retail store or in the electronic product, and is communicatively coupled to the electronic communications network, the electronic mixing apparatus comprising a control circuit, a database, a transceiver circuit, and a sensor;
wherein the sensor obtains location information concerning the current location of the product;
wherein the transceiver circuit is configured to receive the pricing information from the electronic communications network;
wherein the database is configured to store video content to be rendered on the display screen, the database also being configured to store regulatory information, the regulatory information describing a required position and dimensions of a price label on the display screen, the database also storing dimensions of the screen;
wherein the control circuit is configured to:
create, position, and dimension the price label according to the pricing information, the regulatory information, the location information, and the dimensions of the screen;
insert the price label into or over the display content to form labeled pricing content;
transmit the labeled pricing content to the electronic product such that the electronic product renders the labeled pricing content on the display screen;
transmit status information to the central processing center or to an employee in the store via the transceiver circuit, the status information being received from the electronic product and indicating a status of the electronic product such that the employee or a robot can be instructed to re-activate the electronic product when the electronic product has become deactivated.

2. The system of claim 1, wherein the electronic product is a television, a computer, or a smartphone.

3. The system of claim 1, wherein the price label is displayed intermittently on the display screen.

4. The system of claim 1, wherein the control circuit is configured to add tax amounts to the pricing information for inclusion in the label.

5. The system of claim 1, wherein the electronic mixing apparatus is coupled to the electronic product via a USB port at the electronic product.

6. The system of claim 1, wherein the electronic mixing apparatus is coupled to the electronic product via a wired or wireless connection.

7. The system of claim 1, wherein the display content is a movie, an advertisement, or null content.

8. The system of claim 1, wherein the electronic mixing apparatus comprises at least in part a software application.

9. The system of claim 1, wherein the status of the electronic product is activated or deactivated.

10. A method for displaying pricing information on a product display screen, the method comprising:
disposing an electronic product at a retail store, the electronic product including a display screen;
configuring a central processing center to determine and provide pricing information concerning the electronic product;
at an electronic mixing apparatus that is disposed at the retail store or in the electronic product, obtaining location information concerning the current location of the product;
at the electronic mixing apparatus, receiving the pricing information from the central processing center via an electronic communications network;
at the electronic mixing apparatus, storing video content to be rendered on the display screen, storing regulatory information, the regulatory information describing a required position and dimensions of a price label on the display screen, and storing dimensions of the screen;
at the electronic mixing apparatus, creating, positioning, and dimensioning the price label according to the pricing information, the regulatory information, the location information, and the dimensions of the screen, inserting the price label into or over the display content to form labeled pricing content, transmitting the labeled pricing content to the electronic product such that the electronic product renders the labeled pricing content on the display screen, and transmitting status information to the central processing center or to an employee in the store, the status information being received from the electronic product and indicating a status of the electronic product such that the employee or a robot can be instructed to re-activate the electronic product when the electronic product has become deactivated.

11. The method of claim 10, wherein the electronic product is a television, a computer, or a smartphone.

12. The method of claim 10, wherein the price label is displayed intermittently on the display screen.

13. The method of claim 10, further comprising adding tax amounts to the pricing information for inclusion in the label.

14. The method of claim 10, further comprising coupling the electronic mixing apparatus to the electronic product via a USB port at the electronic product.

15. The method of claim 10, further comprising coupling the electronic mixing apparatus to the electronic product via a wired or wireless connection.

16. The method of claim 10, wherein the display content is a movie, an advertisement, or null content.

17. The method of claim 10, wherein the electronic mixing apparatus comprises at least in part a software application.

18. The method of claim 10, wherein the status of the electronic product is activated or deactivated.
